(19) United States
(12) Patent Application Publication
(10) Pub. No.: US 2011/0289025 A1
(43) Pub. Date: Nov. 24, 2011

(54) LEARNING USER INTENT FROM RULE-BASED TRAINING DATA

(75) Inventors: Jun Yan, Beijing (CN); Ning Liu, Beijing (CN); Zheng Chen, Beijing (CN)

(73) Assignee: Microsoft Corporation, Redmond, WA (US)

(21) Appl. No.: 12/783,457

(22) Filed: May 19, 2010

(51) Int. Cl. G06F 15/18; G06N 5/02

(52) U.S. Cl. 706/12; 706/47; 706/52

(57) ABSTRACT

The search intent co-learning technique described herein learns user search intents from rule-based training data and denoises and debiases this data. The technique generates several sets of biased and noisy training data using different rules. It trains each of a set of classifiers using different training data sets independently. The classifiers are then used to categorize the training data as well as any unlabeled data. The classified data confidently classified by one classifier is added to other training data sets, and the wrongly classified data is filtered out from the training data sets, so as to create an accurate training data set with which to train a classifier to learn a user's intent for submitting a search query string or targeting a user for on-line advertising based on user behavior.

Learning to understand user search intent, the intent that a user has when submitting a search query to a search engine, from a user's online behavior is a crucial task for both Web search and online advertising. Machine-learning technologies are often used to train classifiers to learn user search intent. Typically training data to train classifiers for learning user intent is created by humans labeling search queries with a search intent category. This is very labor intensive and it is very time consuming and expensive to generate any training data sets. Thus, it is hard to collect large scale and high quality training data to train classifiers for learning various user intents such as “compare two products”, “plan travel”, and so forth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the search intent co-learning technique described herein learns users' search intents from rule-based training data to provide search intent training data which can be used to train a classifier. The technique generates several sets of biased and noisy training data (e.g., query and associated search intent category) using different rules. The technique trains each classifier of a set of classifiers independently, using each of the different training datasets. The trained classifiers are then used to categorize the user's intent in the training data, as well as any unlabeled search query data, based on the specific user intent categories. The data that is classified by one classifier with a high confidence level are added to other training sets, and the wrongly classified data is filtered out from the training data sets, so as to create an accurate training data set with which to train a classifier to learn a user's intent (e.g., when submitting a search query string).

### DESCRIPTION OF THE DRAWINGS

The specific features, aspects, and advantages of the disclosure will become better understood with regard to the following description, appended claims, and accompanying drawings where:

FIG. 1 is an exemplary architecture for employing one exemplary embodiment of the search intent co-learning technique described herein.

FIG. 2 depicts a flow diagram of an exemplary process for employing one embodiment of the search intent co-learning technique.

FIG. 3 depicts a flow diagram of another exemplary process for employing one embodiment of the search intent co-learning technique.

FIG. 4 is a schematic of an exemplary computing device which can be used to practice the search intent co-learning technique.

### DETAILED DESCRIPTION

In the following description of the search intent co-learning technique, reference is made to the accompanying drawings, which form a part thereof, and which show by way of illustration examples by which the search intent co-learning technique described herein may be practiced. It is to be understood that other embodiments may be utilized and structural changes may be made without departing from the scope of the claimed subject matter.

1.0 Search Intent Co-Learning Technique.

The following sections provide an overview of the search intent co-learning technique, as well as an exemplary architecture and processes for employing the technique. Mathematical computations for one exemplary embodiment of the technique are also provided.

1.1 Overview of the Technique

With the rapid growth of the World Wide Web, search engines are playing a more indispensable role than ever in the daily lives of Internet users. Most current search engines rank and display search results returned in response to a user's search query by computing a relevance score. However, classical relevance-based search strategies may often fail in satisfying an end user due to the lack of consideration of the real search intent of the user. For example, when different users search with the same query “Canon 5D” under different contexts, they may have distinct intentions such as to buy a Canon 5D camera, to repair a Canon 5D camera, or to find a user manual for a Canon 5D camera. The search results about Canon 5D repairing obviously cannot satisfy the users who want to buy a Canon 5D camera. Thus, learning to understand the true user intents behind the users' search queries is becoming a crucial problem for both Web search and behavior-targeted online advertising.

Though various popular machine learning techniques can be applied to learn the underlying search intents of users, it is generally laborious or even impossible to collect sufficient labeled high quality training data for such a learning task. Despite laborious human labeling efforts, many intuitive insights, which can be formulated as rules, can help generate small scale possibly biased and noisy training data. For example, to identify whether a user has the intent to compare different products, several assumptions may help to make this judgment. Generally, it may be assumed that 1) if a user submits a query with an explicit intent expression, such as “Canon 5D compare with Nikon D300”, he or she may want to compare products; and 2) if a user visits a website for products comparison, such as www.carcompare.com, and the dwell time (the time the user spends on the website) is long, then he or she may want to compare products. Though all these rules satisfy human common sense, there are two major limitations if these rules are directly used to infer user intent ground truth (e.g., the correct user intent label for a query). First, the coverage of each rule is often small and thus the training data may be seriously biased and insufficient. Second, the training data are usually noisy (e.g., contain incorrectly labeled data) since no matter which rule is used, exceptions may exist.

In one embodiment, the search intent co-learning technique described herein tackles the problem of classifier learning from biased and noisy rule-generated training data to learn a user's intent when submitting a search query. The technique first generates several datasets of training data using different rules, which are guided by human knowledge (e.g., as discussed in the example paragraph above). Then, the technique independently trains each classifier of a group of classifiers based on an individual training dataset (e.g., one for each rule). These trained classifiers are further used to categorize both the training data and any unlabeled data that needs to be classified. One basic assumption of the technique is that the data samples classified by each classifier with a high confidence level are correctly classified. Based on this assumption, data confidently classified (e.g., data classified with a high confidence level) by one classifier are added to the training sets for other classifiers and incorrectly classified data (e.g., data mislabeled and classified with a low confidence score) are filtered out from the training datasets. This procedure is repeated iteratively, and as a result, the bias of the training data is reduced and the noisy data in the training datasets is removed.

The technique can significantly reduce human labeling efforts of training data for various search intents of users. In one working embodiment, the technique improves classifier learning performance by as much as 47% in contrast to directly utilizing biased and noisy training data.

1.2 Exemplary Architecture.

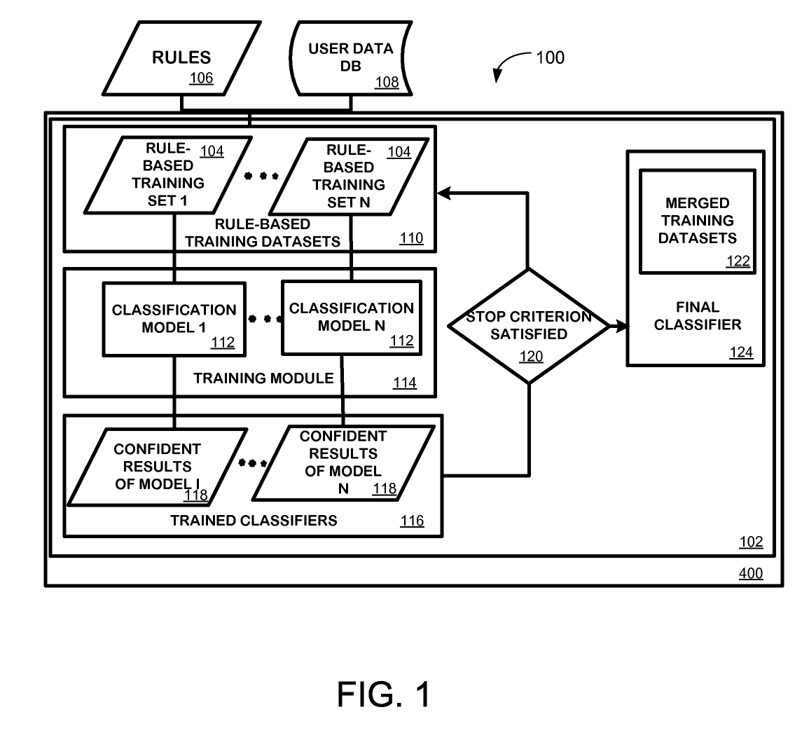

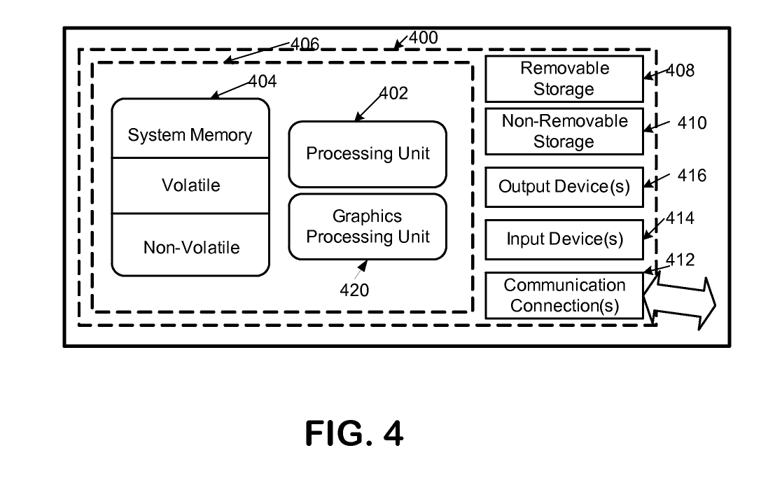

FIG. 1 provides an exemplary architecture 100 for employing one embodiment of the search intent co-learning technique. As shown in FIG. 1, the architecture 100 employs a search intent co-learning module 102 that resides on a computing device 400, such as will be discussed in greater detail with respect to FIG. 4. Different rule-based training data sets 104 are generated from input rules 106 and user behavior data 108, in a rule-based data set creation module 110. It should be noted that each rule-based training data set 104 can also include data that has not been labeled (e.g., it has not been categorized into a search intent category based on a rule). Each classifier of a group of classifiers 112 are then trained independently in a training module 114, each using a different rule-based training data set. The group of trained classifiers 116 is then used to categorize the rule-based sets of training data and any unlabeled data using the classifiers 116. A confidence level 118 of each of the categorized rule-based sets of training data and any unlabeled data is obtained. For each classifier, for the training data and any unlabeled data classified by the classifier with a high confidence level, the training data and unlabeled data classified with a high confidence level and a label matching the rule-based training are added to the other training data sets, and the training data not classified with a high level of confidence is added into the unlabeled data. The process from initially training the classifiers through dispositioning the data based on confidence level are repeated until a stop criteria 120 has been met. The rule-based training data sets are then merged to create a final training data set 122 that is denoised and unbiased. The final training data set can then be used to train a new classifier 124.

Details of the computations of this exemplary embodiment are discussed in greater detail in Section 1.4.

1.3 Exemplary Processes Employed by the Search Intent Co-Learning Technique.

The following paragraphs provide descriptions of exemplary processes for employing the search intent co-learning technique. It should be understood that some in some cases the order of actions can be interchanged, and in some cases some of the actions may even be omitted.

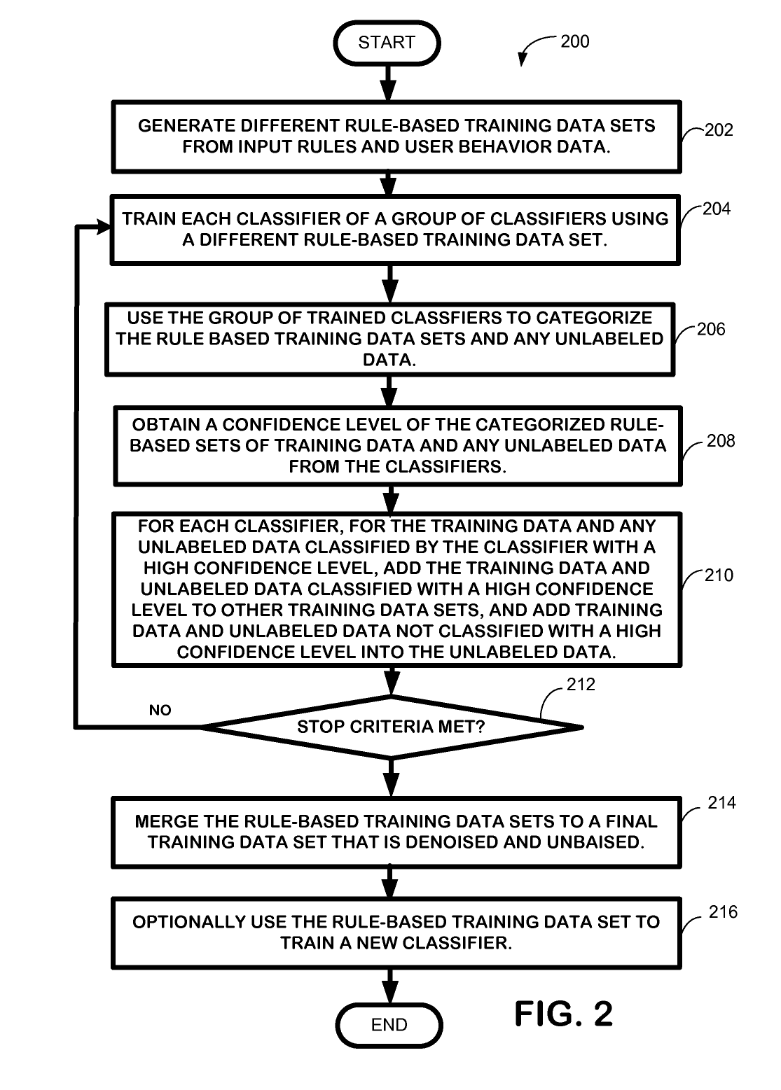

FIG. 2 depicts an exemplary computer-implemented process 200 for automatically generating a training data set for learning user intent when performing a search according to one embodiment of the search intent co-learning technique. As shown in block 202, different rule-based training data sets are generated from input rules and user behavior data. For example, a particular rule-based data set may be generated for a given rule (e.g., user intent is to compare products). These rule-based training data sets will however be noisy (incorrectly labeled) and biased. Also, each rule-based training data set can also include data that has not been labeled (e.g., it has not been categorized into a search intent category based on a rule). Each classifier of a group of classifiers is trained using a different rule-based training data set, as shown in block 204. The group of trained classifiers is then used to categorize the rule-based sets of training data and any unlabeled data (e.g., query data where the user intent has not been labeled or categorized), as shown in block 206. As shown in block 208, a confidence level of the categorized rule-based sets of training data and any unlabeled data is obtained from the classifiers. For each classifier, as shown in block 210, for the training data and any unlabeled data classified by the classifier with a high confidence level, the training data and unlabeled data classified with a high confidence level are added to other training data sets. Training data not classified with a high level of confidence is added into the unlabeled data, as shown in block 212. Blocks 204 thorough 212 are then repeated until a stop criteria has been met. This process denoises and unbiases the training data. The stop criteria could be, for example, that the amount of data added to the training data sets is below a threshold or that a certain number of iterations of repeating blocks 204 through 212 have been completed. The rule-based training data sets are then merged to a final training data set that is denoised and unbiased (block 214) and that can be used to train a new classifier, as shown in block 216.

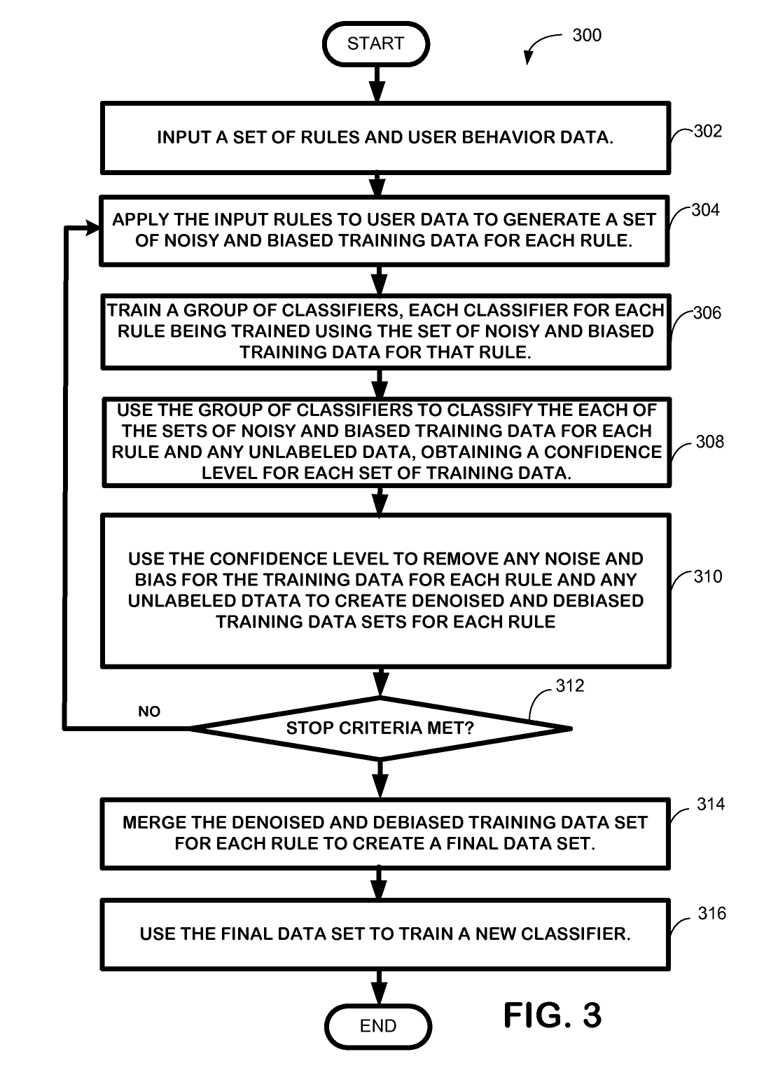

FIG. 3 depicts another exemplary computer-implemented process 300 for automatically generating a training data set for learning user intent in accordance with one embodiment of the technique. In this embodiment rules and user behavior data are input, as shown in block 302. The input rules are applied to the user data to generate a set of noisy and biased training data for each rule, as shown in block 304. Again, each rule-based training data set can also include data that has not been labeled (e.g., it has not been categorized into a search intent category based on a rule). A group of classifiers are then trained as shown in block 306, each classifier for each rule being trained using the set of noisy and biased training data for that rule. The trained classifiers are then used to classify each of the sets of noisy and biased training data for each rule and any unlabeled data. A confidence level is also determined for each set of noisy and biased training data for that rule and any unlabeled data, as shown in block 308. The confidence level is then used to remove any noise and bias from the training data for that rule and any unlabeled data to create denoised and debiased training data sets for each rule, as shown in block 310. Blocks 304 through 310 are repeated until a stop criteria has been met, as shown in block 312. The denoised and debiased training sets for each rule are then merged (block 314), and the merged denoised and debiased training data sets are then used set to train a new classifier to classify user intent when issuing a search or to target advertising based on user search intent, as shown in block 316.

1.4 Mathematical Computations for One Exemplary Embodiment of the Search Intent Co-Learning Technique.

The exemplary architecture and exemplary processes having been provided, the following paragraphs provide mathematical computations for one exemplary embodiment of the search intent co-learning technique. In particular, the following discussion and exemplary computations refer back to the exemplary architecture previously discussed with respect to FIG. 1.

1.4.1 Problem Formulation

Recently, the number of search engine users has dramatically increased. Higher demands from users are making classical keyword relevance-based search engine results unsatisfactory due to the lack of understanding of the search intent behind users' search queries. For example, if a user's query is “how much canon 5D lens”, the intent of the user could be to check the price and then to buy a lens for his digital camera. If a user's query is “Canon 5D lens broken”, the user intent could be to repair his/her Canon 5D lens or to buy a new one. However, in practice, if a user currently submits these two queries to two commonly used commercial search engines independently the search results can be unsatisfactory though the keyword relevance matches well. For example, in the results of a first search engine, nothing related to the Canon 5D lens price is returned. In the results of a second search engine, nothing about Canon 5D lens repair and maintenance is returned. Motivated by these observations, the search intent co-learning technique, in one embodiment, learns user intents based on predefined categories from user search behaviors.

1.4.1.1 Predefined User Behavioral Categories

In one embodiment, the search intent co-learning technique considers user search intents as predefined user behavioral categories. Each application scenario may have a certain number of user search intents. In the following discussion, only one user search intent is considered for demonstration purposes, namely, “compare products”. This intent is considered as a predefined category. The goal is to learn whether a user has this search intent in a current query based on the query text and her search behaviors such as other submitted queries and the clicked URLs before current query. A series of search behaviors by the same user is known as a user search session. Table 1 introduces an example of a user search session, where the “SessionID” is a unique ID to identify one user search session. The item “Time” is the time of one user event, which is either the time the user submitted a query (“Query”) or the user clicked a URL (“URL”) with an input device. The search intent label is a binary value to indicate whether the user has the predefined intent, which is the target for a classifier (e.g., certain algorithm) to learn.

TABLE 1
An Exemplary User Search Session

| | | | | Intent label |
|---|---|---|---|---|
| | | | | (compare?) |
| SessionID | Time | Query | URL | 1 = True |
| GEN0867 | Sep. 11, 2001 | Canon 5D | Null | 0 |
| | 22:03:06 | | | |
| GEN0867 | Sep. 11, 2001 | Null | http://www.DC . . . | 0 |
| | 22:03:06 | | | |
| GEN0867 | Sep. 11, 2001 | Null | http://www.amazon . . . | 0 |
| | 22:03:06 | | | |
| GEN0867 | Sep. 11, 2001 | Nikon | Null | 1 |
| | 22:03:06 | D300 | | |
| GEN0867 | Sep. 11, 2001 | Null | http://www.amazon . . . | 0 |
| | 22:03:06 | | | |

1.4.1.2 Bias and Noise

As mentioned previously, it is laborious or even impossible to collect large scale high quality training data for user search intent learning. Therefore, in one embodiment, the search intent co-learning technique uses a set of rules to initialize the training data (see, for example, FIG. 1, blocks 104, 106, 108, 110). The concepts of “bias” and “noise” for training data are first defined in order to make the following description of the mathematical details of one embodiment of the technique more clear.

There is literature in the machine learning community that has considered the “bias” problem and has very similar definitions for “bias” in training data. For purposes of the following discussion, the definitions of “bias” and “noise” are as follows. Mathematically, each data sample in a training data set is represented as (x,y,s)εX×Y×S, where X stands for the feature space, Y stands for the domain of user search intent labels and S is binary. In other words, x is a data sample, a feature vector, y is its corresponding true class label, and the variable s indicates whether x is selected as training data with 1 for being selected. Thus, the definitions for bias and noise in the training data are as follows.

Definition 1 for Bias: Given a training dataset D⊂X×Y×S, for any data sample (x,y,s)εD, D is biased if the samples with some special feature are more likely to be selected in the training data, i.e., the probability P(s=1)≠P(s=1|x). On the other hand, if ∀xεX, P(s=1)=P(s=1|x), the dataset D is unbiased.
Definition 2 for Noise: A training dataset D⊂X×Y×S is assumed to be noisy if and only if there exists a non-empty subset P⊂D such that for any (x,y,s)εP, one has y′≠y, where y′ is the observed label of x. In other words, the labels in a subset of the training data are not the true labels the subset of the training data should have.

1.4.1.3 Problem Statement

From Definition 1, one can see that if one uses rules to generate a training dataset, the training data will be seriously biased (e.g., one feature is more likely to be selected) since the data are generated from some special features, i.e. rules. From Definition 2, one can assume that the rule-generated training data may have a high probability of being noisy since one cannot guarantee the definition of perfect rules. Thus, the problem to be solved by the search intent co-learning technique can then defined as follows,

Without laborious human labeling work, is it possible to train a user search intent classifier using rule-generated training data, which are generally noisy and biased? Given K sets of rule-generated training datasets Dₖ, k=1, 2 . . . K , how can one train the classifier G: X→Y on top of these biased and noisy training data sets with good performance?

1.4.2 Obtaining Training Data Sets and Training a Classifier While Reducing Noise and Bias.

The terminologies to be used in the following description are provided as follows. As discussed with respect to FIG. 1, each training data set can have labeled and unlabeled data. In the exemplary embodiment of FIG. 1, blocks 104, 106, 108, 110 pertain to obtaining the initial training data sets and blocks 112, 114 pertain to training each of the classifiers. Mathematically, this can be described as follows. Suppose one has K sets of rule-generated training data Dₖ, k=1, 2 . . . K , (e.g., block 104 of FIG. 1), which are possibly noisy and biased, and a set of unlabeled user behavioral data Dᵤ. Each data sample in the training datasets is represented by a triple (xₖⱼ,yₖⱼ,sₖⱼ=1), j=1, 2, . . . |Dₖ|, where xₖⱼ stands for the feature vector of the j^{th} data sample in the training data Dₖ, yₖⱼ is its class label and |Dₖ| is the total number of training data in Dₖ. On the other hand, each unlabeled data sample, i.e. the user search session that could not be covered by the rules, is represented as (xᵤⱼ,yᵤⱼ,sᵤⱼ=0), j=1, 2, . . . |Dᵤ|. Suppose for any xεX, all the features constituting the feature space are represented as a set [(F={fᵢ=1, 2, . . . M}. Suppose among all the features F, some have direct correlation to the rules, that is they are used to generate the training dataset Dₖ. These features are denoted by F′ₖ⊂F, which constitute a subset of F. Let Fₖ=F−F′ₖ be the subset of features having no direct correlation to the rules used for generating training dataset Dₖ. Given a classifier G: Fₛ→Y, where Fₛ⊂F is any subset of F, G^{o} is used to represent an untrained classifier and use Gₖ¹ to represent the classifier trained by the training data Dₖ. Suppose G⁰(Dₖ|F_{K}) means to train the classifier G^{o} by training dataset Dₖ using the features Fₖ⊂F, one has Gₖ¹=G⁰(Dₖ|Fₖ), k=1, 2, . . . K . For the trained classifier Gₖ¹, let Gₖ¹(xᵤⱼεDᵤ|F) stand for classifying xᵤⱼ using features F. One can assume for each output result of trained classifier Gₖ¹, it can output a confidence score. Let

Gₖ¹(xᵤⱼεDᵤ|F)=yᵤⱼ*(cᵤⱼ),

where yᵤⱼ* is the class label of xᵤⱼ assigned by Gₖ¹ and the cᵤⱼ is the corresponding confidence score.

After generating a set of training data Dₖ, k=1, 2 . . . K based on rules (e.g., blocks 104, 106, 108, 110 of FIG. 1) the technique first trains the classifier G^{o} by Dₖ, k=1, 2 . . . K independently (block 112). The result is a set of K classifiers (block 114)

Gₖ¹=G⁰(Dₖ|Fₖ), i=1, 2, . . . K,

Note that the reason why the technique uses Fₖ to train a classifier on top of Dₖ instead of using the full set of features F is that Dₖ is generated from some rules correlated to F′ₖ, which may overfit the classifier Gₖ¹ if one does not exclude them. After each classifier Gₖ¹ is trained by Dₖ, the technique uses Gₖ¹ to classify the training dataset Dₖ itself and obtains a confidence score (blocks 116, 118). A basic assumption of the technique is that the confidently classified instances by classifier Gₖ¹, k=1, 2, . . . K have high probability to be correctly classified. Based on this assumption, for any xₖⱼεDₖ, if the confidence score of the classification is larger than a threshold, i.e. cₖⱼ>θₖ and the class label assigned by the classifier is different from the class label assigned by the rule, i.e. y′ₖⱼ≠yₖⱼ*, then xₖⱼ is considered as noise in the training data Dₖ. Note that here yₖⱼ* is the label of xₖⱼ assigned by classifier, y′ₖⱼ is its observed class label in training data, and yₖⱼ is the true class label, which is not observed. The technique excludes it from Dₖ and puts it into the unlabeled dataset Dᵤ. Thus the training data is updated by

Dₖ=Dₖxₖⱼ, Dᵤ=Dᵤ∪xₖⱼ.

Using this procedure the technique can gradually remove the noise generated in the rule-generated training data.

Additionally, once the classifiers have been trained, the technique thus uses the classifier Gₖ¹, k=1, 2, . . . K to classify the unlabeled data Dᵤ independently (block 116). Based on the same assumption that the confidently classified instances by classifier have high probability to be correctly classified, for any data belonging to Dᵤ, if the confidence score of the classification is larger than a threshold, i.e. cᵤⱼ>θᵤ where Gₖ¹(xᵤⱼεDᵤ|F)=yᵤⱼ*(cᵤⱼ), the technique includes xᵤⱼ into the training dataset. In other words,

Dᵤ=Dᵤ−xᵤⱼ, Dᵢ=Dᵢ∪xᵤⱼ, i=1, 2 . . . K, i≠k.

In this manner the technique can gradually reduce the bias of the rule-generated training data.

Thus, the rule-generated training datasets are updated. According to the definition of “noise” of the training data, if the basic assumption, i.e. the confidently classified instances by classifier Gₖ¹, k=1, 2, . . . K have high probability to be correctly classified, holds true, the noise in the initial rule-generated training datasets can be reduced.

Theorem 1 below introduces the details of the assumption and the theoretical guarantees to reduce noises in training datasets.

Theorem 1: let D′ₖ be the largest noisy subset in Dₖ, if the confidently classified instances by classifier Gₖ¹, k=1, 2, . . . K have high probability to be correctly classified, i.e.
(1) If xₖⱼεDₖ and cₖⱼ>θₖ, where Gₖ¹(xₖⱼεDₖ|Fₖ)=yₖⱼ*(cₖⱼ) one can assume the probability

P(yₖⱼ≠yₖⱼ*)<ε≈0
(2) If xᵤⱼεDᵤ and cᵤⱼ>θᵤ, where Gₖ¹(xᵤⱼεDᵤ|F)=yᵤⱼ*(cᵤⱼ), one can assume the probability

P(yᵤⱼ≠yₖⱼ*|cᵤⱼ>θᵤ)<minₖ{|D′ₖ|/|Dₖ|,k=1, 2, . . . K})

then after one round of iteration, the noise ratio |D′ₖ|/|Dₖ|, k=1, 2, . . . K in training data sets Dₖ is guaranteed to decrease.

[symbol]

The technique can thus update the training sets at each round by filtering out old and adding new training data. Let |D′ₖ|ₙ/|Dₖ|ₙ be the noise ratio in Dₖ at the n^{th} iteration, based on Theorem 1, one has,

$${lim}_{n \to ∞} p ( {\vert {D}_{k}^{′} \vert}_{n} / {\vert {D}_{k} \vert}_{n} > 0 ) = 0$$

This means that after a large number of iterations, the probability of noise ratio not converging to zero will approach zero.

On the other hand, some unlabeled data are added into the training datasets. According to the definition of “bias” in training data, the bias of the training data can be reduced along with the iteration process. Mathematically, suppose the P_{n,k}(sᵤⱼ=1|xᵤⱼ) is the probability of a data sample to be involved in the training data Dₖ at the iteration n conditioned on this data sample is represented as a feature vector xᵤⱼ and P(s=1) is the probability of any data sample in D is considered as a training data sample. The goal is to prove that after n iterations, for each training dataset, one has P_{n,k}(sᵤⱼ=1|xᵤⱼ)=P(s=1). Theorem 2 confirms this assumption.

Theorem 2: Given a set of rules, if for any unlabeled data xᵤⱼ, there exists a classifier Gₖ¹ to bias xᵤⱼ at an iteration n, i.e.,

∃k,n s.t. P_{n,k}(sᵤⱼ=1|xᵤⱼ)>Pₖ(s=1)

where Pₖ(s=1) is the probability of any data sample is involved in training dataset Dₖ, one has

$${lim}_{n \to ∞} {P}_{n , k} ( {s}_{ui} = 1 \vert {x}_{ui} ) = P ( s = 1 ) , k = 1 , 2 , … K .$$

[symbol]

The assumption of Theorem 2 tells one that when the rules are designed for initializing the training datasets, one should utilize as many rules as possible to make more unlabeled data to be potentially biased by one of the classifiers Gₖ¹, k=1, 2, . . . K. At each iteration, the technique uses the refined training datasets Dₖ, i=1, 2, . . . K as the initial training datasets to repeat the same procedure. According to Theorem 1 and 2, after n rounds of iterations, both noise and bias in the training datasets are theoretically guaranteed to be reduced.

Referring back to FIG. 1, in one embodiment, the iteration stopping criteria is defined as “if |{xᵤⱼ|xᵤⱼεDᵤ,cᵤⱼ>θᵤ}|<n or the number of iterations reaches N, then stop the iteration”. After the iterations stop (block 120), K updated training datasets are obtained with both noise and bias reduction. Finally, the technique merges of all these K training datasets into one (block 122). Thus, in one embodiment the technique can train a final classifier (block 124) as

$${G}^{1} = {G}^{0} ( {{⋃}_{i = 1}}^{k} {D}_{i} \vert F )$$

Table 2 provides an exemplary summarized version of the previous discussion.

TABLE 2
Exemplary Procedure for Classifying User Intent

```
Input: Rule-generated training datasets Dₖ, k = 1,2,...K
and the unlabeled data Dᵤ. A basic classification
model G⁰: X → Y.
Output: a classifier G¹: X → Y trained by Dₖ, k = 1,2,...K
Step 1. Train classifiers on all rule-generated training datasets
independently
Gₖ¹ = G⁰(Dₖ|Fₖ), k = 1,2...K.
Step 2. For the output of Gₖ with high confidence scores, add them to
other training datasets
D_{i,}, i = 1,2...K, i ≠ k, to update all Dₖ, k = 1,2,...K
Gₖ¹(xₖⱼ ε Dₖ|Fₖ) = yₖⱼ * (cₖⱼ).
If cₖⱼ > θₖ and yₖⱼ^{′} ≠ yₖⱼ*
Dₖ = Dₖ − xₖⱼ
Dᵤ = Dᵤ ∪ xₖⱼ
Gₖ¹(xᵤⱼ ε Dᵤ|Fₖ) = yᵤⱼ * (cᵤⱼ)
If cᵤⱼ > θᵤ
Dᵤ = Dᵤ − xᵤⱼ
    For each i = 1,2...K, i ≠ k
    Dᵢ = Dᵢ ∪ xᵤⱼ
Step 3. Repeat step 1 and step 2 iteratively until number of
iterations reaches N or
| {xᵤᵢ | xᵤᵢ ε Dᵤ, cᵤᵢ > θᵤ} |< n |,
Otherwise
${G}^{1} = {G}^{0} ( {{⋃}^{K}}_{k = 1} {D}_{k} \vert F ) .$
```

2.0 The Computing Environment

The search intent co-learning technique is designed to operate in a computing environment. The following description is intended to provide a brief, general description of a suitable computing environment in which the search intent co-learning technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 4 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 4, an exemplary system for implementing the search intent co-learning technique includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, device 400 may also have additional features/functionality. For example, device 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400.

Device 400 also can contain communications connection(s) 412 that allow the device to communicate with other devices and networks. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 400 may have various input device(s) 414 such as a display, keyboard, mouse, pen, camera, touch input device, and so on. Output device(s) 416 devices such as a display, speakers, a printer, and so on may also be included. All of these devices are well known in the art and need not be discussed at length here.

The search intent co-learning technique may be described in the general context of computer-executable instructions, such as program modules, being executed by a computing device. Generally, program modules include routines, programs, objects, components, data structures, and so on, that perform particular tasks or implement particular abstract data types. The search intent co-learning technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for automatically generating a training data set for learning user intent when performing a search, comprising:
using a computing device for:
(a) generating different rule-based training data sets from input rules and user behavior data;
(b) training each classifier of a group of classifiers using a different rule-based training data set;
(d) using the group of classifiers to categorize the rule-based sets of training data and any unlabeled data;
(c) obtaining a confidence level of the categorized rule-based sets of training data and any unlabeled data obtained from the classifiers;
(e) for each classifier, for the training data and any unlabeled data classified by the classifier with a high confidence level, adding the training data and unlabeled data classified with a high confidence level to other training data sets, and adding training data not classified with a high level of confidence into the unlabeled data;
(f) repeating steps (b) through (e) until a stop criteria has been met; and
(g) merging the rule-based training data sets to a final training data set that is denoised and unbiased that can be used to train a new classifier.

2. The computer-implemented process of claim 1, further comprising using the final training data set to train a new classifier.

3. The computer-implemented process of claim 1, further comprising for each classifier, for the training and unlabeled data classified by the classifier with a low confidence level, discarding the training and unlabeled data classified with a low confidence level.

4. The computer-implemented process of claim 1 wherein the stop criteria further comprises a predetermined number of iterations.

5. The computer-implemented process of claim 1 wherein the stop criteria further comprises the amount of added training data and unlabeled data classified with a high confidence level to other training data sets is below a prescribed threshold.

6. The computer-implemented process of claim 1, further comprising if the training data that is classified has a high confidence level, but the label of the training data is different than that of a rule-based label, then determining that the training data that is classified is noise and not adding the training data that is noise to the other training data sets.

7. A computer-implemented process for automatically generating a training data set for learning user intent, comprising:
using a computing device for:
inputting rules and associated user behavior data regarding user search intent;
applying the input rules to the user data to generate a data set of noisy and biased training data for each rule;
training a group of classifiers, each classifier being independently trained using a set of corresponding noisy and biased training data for a given rule;
using the group of trained classifiers to categorize the rule-based sets of training data and any unlabeled data;
determining a confidence level for each set of noisy and biased training data classified;
using the confidence level to remove any noise and bias from the training data for the corresponding rule and any unlabeled data, to create a denoised and debiased training data set for each rule;
merging the denoised and debiased training sets for each rule; and
using the merged denoised and debiased training set to train a new classifier to classify user intent.

8. The computer-implemented process of claim 7, wherein the new classifier is used to learn user intent to improve user search results returned in response to a search query.

9. The computer-implemented process of claim 7, wherein the new classifier is used to learn user intent to target a user with on-line advertising.

10. The computer-implemented process of claim 1, wherein the user data comprises:
a set of users and for each user, a time the user conducted the user behavior, a query, a URL of any search results and a user intent label.

11. The computer-implemented process of claim 1, wherein using the confidence level to remove any noise and bias from the training data for that rule and any unlabeled data to create a denoised and debiased training data set for each rule, further comprising:
(a) using the group of classifiers to categorize the rule-based sets of noisy and biased training data and any unlabeled data;
(b) obtaining a confidence level of the categorized rule-based sets of training data and any unlabeled data from the classifiers;
(c) for each classifier, for the training data and any unlabeled data classified by the classifier with a high confidence level, adding the training data and unlabeled data classified with a high confidence level to other training data sets, and adding training data not classified with a high level of confidence into the unlabeled data;
(d) repeating steps (a) through (c) until a stop criteria has been met.

12. The computer-implemented process of claim 11 wherein the stop criteria further comprises a predetermined number of iterations.

13. The computer-implemented process of claim 11 wherein the stop criteria further comprises the amount of added training data and unlabeled data classified with a high confidence level to other training data sets being small.

14. The computer-implemented process of claim 11, further comprising if the training data that is classified has a high confidence level, but the label of the training data is different than that of a rule-based label, then determining that the training data that is classified is noise and not adding the training data that is noise to the other training data sets.

15. The computer-implemented process of claim 7, wherein noisy training data is training data where labels indicating user intent in a subset of the noisy training data do not indicate true user intent.

16. The computer-implemented process of claim 7, wherein biased training data is training data where a subset of the biased training data with a special feature are more likely to be selected in the training data.

17. A system for automatically generating a training data set for learning user intent, comprising:
a general purpose computing device;
a computer program comprising program modules executable by the general purpose computing device, wherein the computing device is directed by the program modules of the computer program to,
(a) generate different rule-based training data sets from input rules and user behavior data;
(b) train each classifier of a group of classifiers using a different rule-based training data set;
(d) use the group of trained classifiers to categorize the rule-based sets of training data and any unlabeled data;
(e) obtain a confidence level of the categorized rule-based sets of training data and any unlabeled data obtained from the classifiers;
(f) for each classifier, for the training data and any unlabeled data classified by the classifier with a high confidence level, adding the training data and unlabeled data classified with a high confidence level and a label matching the rule-based training to other training data sets, and adding training data not classified with a high level of confidence into the unlabeled data;
(g) repeat steps (b) through (f) until a stop criteria has been met; and
(g) merge the rule-based training data sets to create a final training data set that is denoised and unbiased.

18. The system of claim 18, further comprising a module to use the final training data set to train a new classifier.

19. The system of claim 17, wherein the training data and the unlabeled data is classified into predefined search intent categories.

20. The system of claim 17, wherein the unlabeled data is classified independently from the training data.
